(19) United States
(12) Patent Application Publication
(10) Pub. No.: US 2019/0076911 A1
(43) Pub. Date: Mar. 14, 2019

(54) METHOD FOR COATING AND FORGING VEHICLE WHEEL

(71) Applicant: Chin Hung Chen, New Taipei City (TW)

(72) Inventor: Chin Hung Chen, New Taipei City (TW)

(21) Appl. No.: 16/126,924

(22) Filed: Sep. 10, 2018

Related U.S. Application Data
(60) Provisional application No. 62/555,825, filed on Sep. 8, 2017.

(51) Int. Cl. B21D 53/30; B23P 15/00; B60B 21/00

(52) U.S. Cl. CPC B21D 53/30; B23P 15/00; B60B 21/00; B60B 2310/661; B60B 2310/208; B60B 2310/612; B60B 2310/616; B60B 2900/131

(57) ABSTRACT

In one aspect, a method for forging a vehicle wheel with three-dimensional features may include steps of utilizing toe-clamps and center collets to reduce chatter marks and the effects of vibrations and harmonics; employing a parametric CNC program which allows for feed rates and spindle RPM speeds that are specific to the process of the vehicle wheel design; utilizing end-mills, bull-nose end-mills, ball-mills, chamfer tools, V-tools, custom rivet tools, and other commonly used CNC milling tools to machine the sides of the spokes on the wheels; utilizing a coolant to operate the CNC machine; providing a tool to make the three-dimensional features on the wheel; cleaning the wheel to remove coolant and debris remaining on the wheel; and painting selected areas of the wheel.

### CROSS-REFERENCE TO RELATED APPLICATIONS

This application claims priority under 35 U.S.C. § 119 (e) to U.S. Provisional Patent Application Ser. No. 62/555,825, filed on Sep. 8, 2017, the entire contents of which are hereby incorporated by reference.

### FIELD OF THE INVENTION

The present invention relates to vehicle wheels, and more particularly to a method for using a computer numerical control (CNC) machine with a specially-design bit to generate coated vehicle wheels.

### BACKGROUND OF THE INVENTION

Vehicle wheels are subjected to extended and rigorous use during the operation of a motor vehicle. As a result of the extended use and rough wear, it is common for the vehicle wheels to be replaced on a regular basis. While in use, vehicle wheels are in constant contact with the tires of the motor vehicle, which results in wear of the vehicle wheel due to sliding wear mechanisms such as abrasion and adhesion.

Vehicle wheels are also made from steel as an inexpensive alternative to aluminum alloys, however, the use of steel does not alleviate the occurrence of wear in the vehicle wheel. Aluminum and its alloys are particularly useful materials for inclusion in metal components of vehicles such as cars, trucks, airplanes, and even for large heavy-duty trucks such as tractor-trailers. In recent years, aluminum or aluminum alloy wheels have been substituted for steel wheels because of their lighter weight and attractive appearance without sacrificing strength. Unfortunately, wear also occurs in highly loaded vehicles with aluminum wheels.

Today, many of the aluminum wheels are formed of three pieces, included two mating halves that form the support rim, plus a centerpiece that includes an aesthetically pleasing design. Three piece aluminum wheels are typically formed by cold working non-heat-treatable aluminum alloys, however, three piece wheels that use cold work alloys have drawbacks such as strength deficiencies in the bolt flange. In addition, wheels made from cold worked alloys often suffer from variable strength properties from part to part and from location to location within a particular part.

To eliminate the shortcomings in three-piece aluminum wheels, one-piece aluminum wheels have been developed. One-piece wheels are manufactured by casting the wheel from a piece of metal. Casting has the advantage of being less time consuming, and more efficient than other types of wheel production. Wheel casting is performed at one time and does not require different pieces to be fit together. However, one disadvantage of cast wheel production is that casting typically does not include the aesthetic features that might be found in a wheel forging processes.

Conventionally, there are two wheel forging processes: a hot and a cold forging process. Most metal wheels are forged hot because the wheels are typically made of either iron or an iron alloy. This is done primarily because if hardening occurs during cold forging, hard materials such as iron and steel would become extremely difficult to work with. Often times, hot forging is utilized to strengthen products by adding additional elements to the product to produce a stronger, more resilient by-product. The computer numeral control (CNC) can also be incorporated into the wheel forging process.

However, conventional wheel forging process can only focus on a specific portion of the wheel and if the forging process needs to be applied on several portions of the wheel, the wheel may have to be disassembled, which may increase the costs of labor and can be time consuming. For example, as shown in FIG. 1, it takes a separate step to coat or forge the rim of the wheel 110 and a connecting portion 120. Similarly, it also takes a separate step to coat or forge the spoke portion 210 and the recessed portion 220 as shown in FIG. 2. Therefore, there remains a need for a new and improved wheel forging technique to overcome the problem presented above.

### SUMMARY OF THE INVENTION

It is an object of the present invention to provide a method for coating wheels without disassembling the wheels to save labor and manufacturing costs.

It is another object of the present invention to provide a method for coating wheels that employs a computer numerical control (CNC) machine with a specially-designed bit.

In one aspect, a passivation method for a silicon carbide (SiC) surface may include steps of providing a silicon carbide surface, depositing a thin metal layer on the silicon carbide surface, forming a first passivation layer on the metal layer at low temperature, and generating a dielectric layer by a reaction between a gas/liquid ambient and the thin metal layer.

In one aspect, a method for coating and polishing a vehicle wheel may include steps of utilizing toe-clamps and center collets to reduce chatter marks and the effects of vibrations and harmonics; employing a parametric CNC program which allows for feed rates and spindle RPM speeds that are specific to the process of the vehicle wheel design; utilizing end-mills, bull-nose end-mills, ball-mills, chamfer tools, V-tools, custom rivet tools, and other commonly used CNC milling tools to machine the sides of the spokes on the wheels; utilizing a coolant to operate the CNC machine; providing a tool to make rivets in the wheel; cleaning the wheel to remove coolant and debris remaining on the wheel; and painting selected areas of the wheel.

In one embodiment, the step utilizing end-mills, bull-nose end-mills, ball-mills, chamfer tools, V-tools, custom rivet tools, and other commonly used CNC milling tools to machine the sides of the spokes on the wheels may further include a step of utilizing a plastic portion which absorbs machine vibration and harmonics to reduce chatter marks on the wheel. In another embodiment, the step of providing a tool to make rivets in the wheel may include a step of providing a peck-drill cycle tool to make rivets in the wheel without the need for forging the rivets.

In a further embodiment, a bit used in the CNC machine may include a main body and a spiral head, which can be used to machine the spokes on the wheels. In another embodiment, the angle of the spiral head can be about 70 degrees. In an exemplary embodiment, a functional head extends from the main body and has a movable drilling unit having four cutting edges and a cutting unit, which are configured to form a three-dimensional feature for the computer numerical control (CNC) machine. In one embodiment, the movable drilling unit has a center hole and a rivet is inserted into the center hole to movably secure the drilling unit to the functional head. In an exemplary embodiment, the movable drilling unit is an artificial diamond to increase the brightness of the wheel during the polishing process.

### BRIEF DESCRIPTION OF THE DRAWINGS

FIG. 1 is a prior art disclosing a conventional method for coating and forging a wheel.

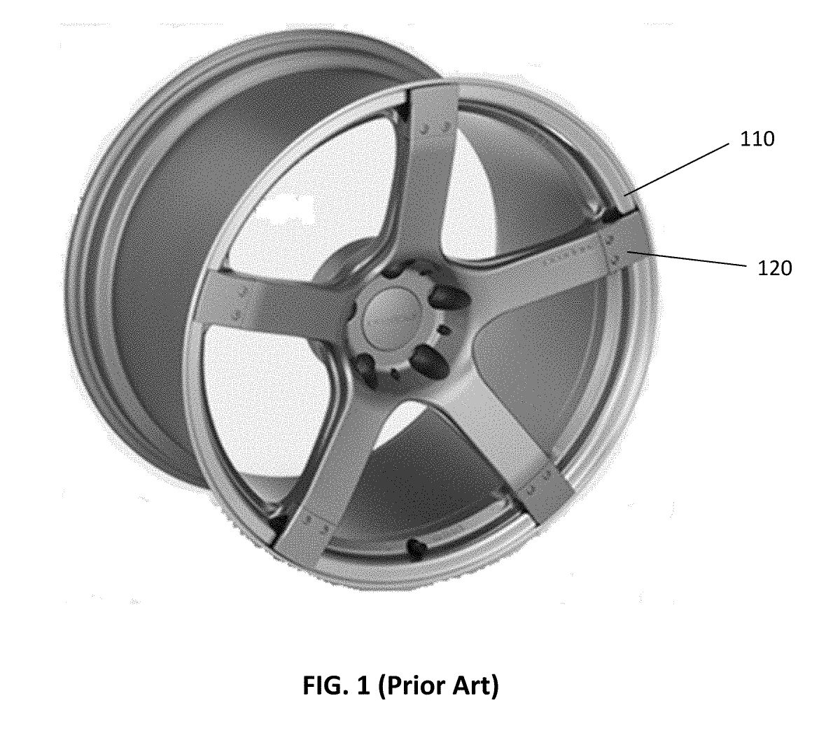

FIG. 2 is also a prior art disclosing a conventional method for coating and forging a wheel.

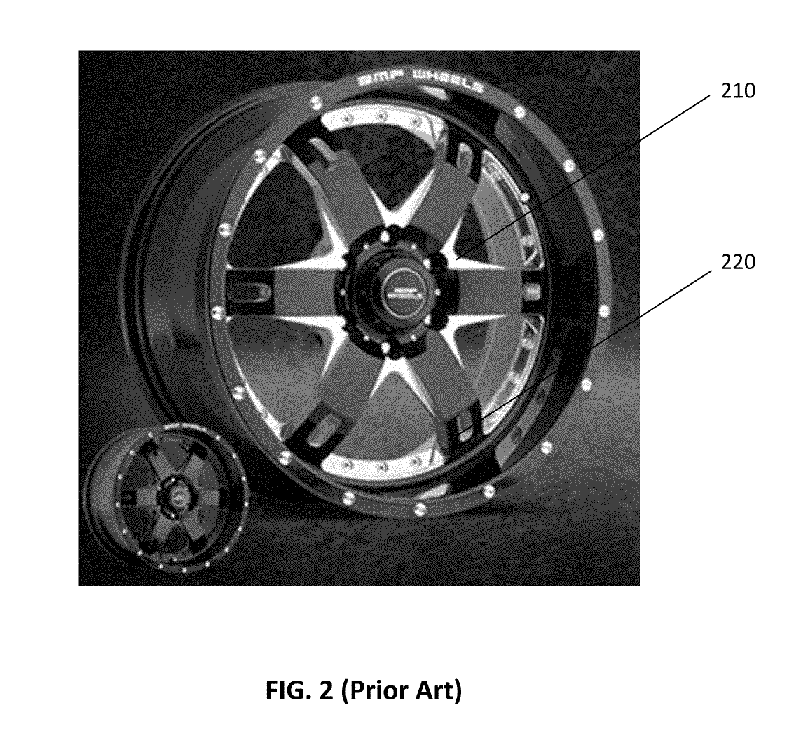

FIG. 3 illustrates a flow diagram for a method for forging a vehicle wheel in the present invention.

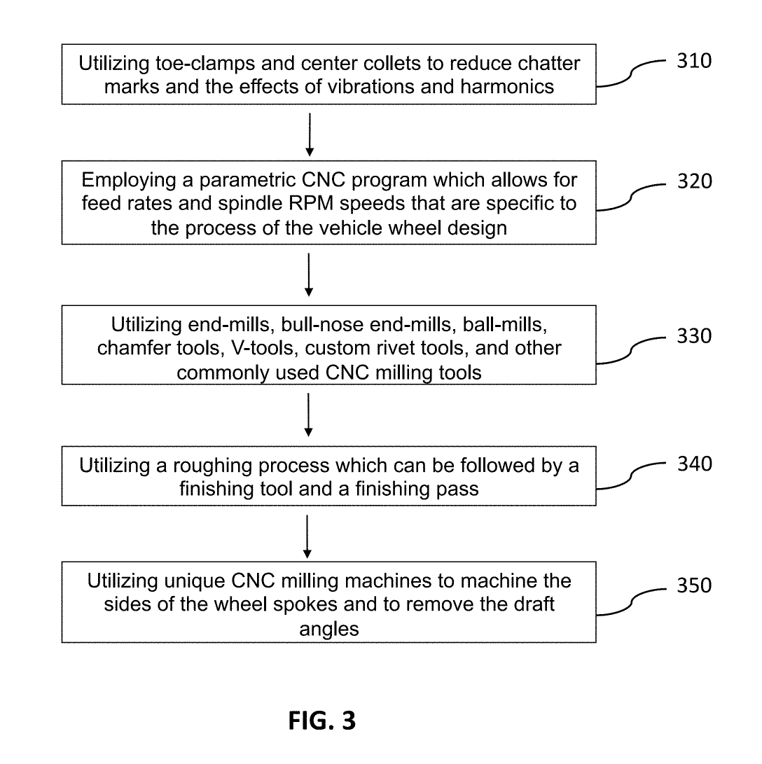

FIGS. 4 to 4b illustrate different styles of bits used in the forging process in the present invention.

FIG. 5 is an exemplary embodiment of the wheel forging process in the present invention.

FIG. 6 illustrates wheels before being polished by the CNC machine with the artificial diamond drilling unit.

FIG. 7 illustrates wheels after being polished by the CNC machine with the artificial diamond drilling unit.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

In one aspect, a method for forging a vehicle wheel with three-dimensional features may include steps of utilizing toe-clamps and center collets to reduce chatter marks and the effects of vibrations and harmonics 310; employing a parametric CNC program which allows for feed rates and spindle RPM speeds that are specific to the process of the vehicle wheel design 320; utilizing end-mills, bull-nose end-mills, ball-mills, chamfer tools, V-tools, custom rivet tools, and other commonly used CNC milling tools to machine the sides of the spokes on the wheels 330; utilizing a coolant to operate the CNC machine 340; providing a tool to make the three-dimensional features on the wheel 350; cleaning the wheel to remove coolant and debris remaining on the wheel 360; and painting selected areas of the wheel 370.

In one embodiment, the step (330) utilizing end-mills, bull-nose end-mills, ball-mills, chamfer tools, V-tools, custom rivet tools, and other commonly used CNC milling tools to machine the sides of the spokes on the wheels may further include a step of utilizing a plastic portion which absorbs machine vibration and harmonics to reduce chatter marks on the wheel. In another embodiment, the step (350) of providing a tool to make rivets in the wheel may include a step of providing a peck-drill cycle tool to make rivets in the wheel without the need for forging the rivets.

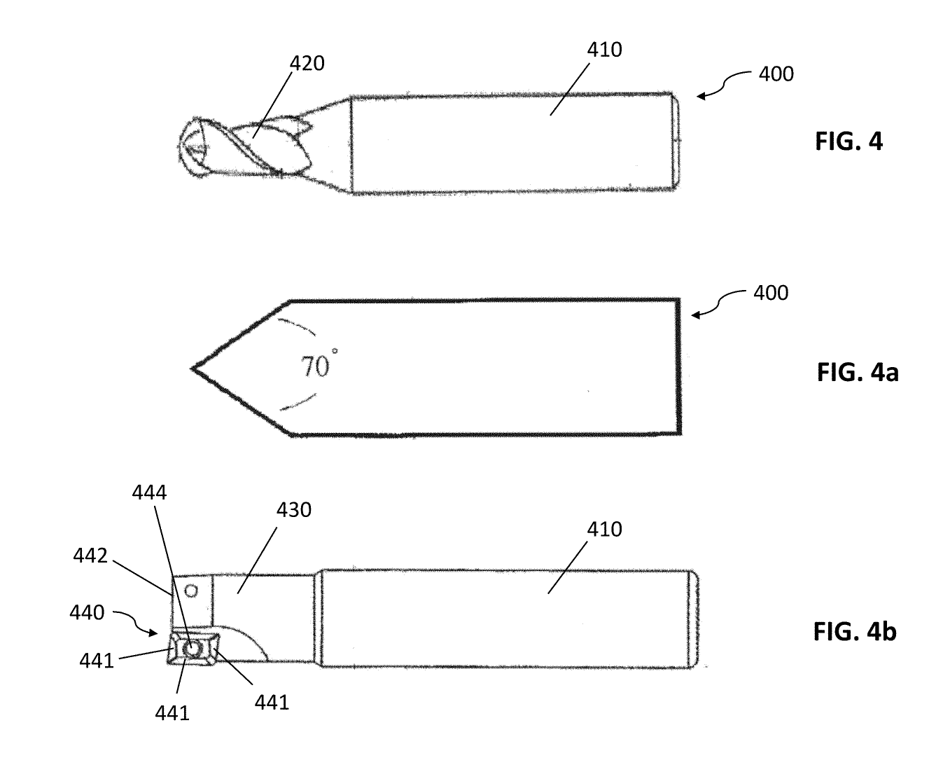

In a further embodiment, a bit 410 as shown in FIG. 4 is used in step 350 to make the three-dimensional features on the wheel. The bit 400 may include a main body 410 and a spiral head 420, which can be used to machine the spokes on the wheels. In another embodiment, the angle of the spiral head 420 can be about 70 degrees as shown in FIG. 4a. In an exemplary embodiment, a functional head 430 extends from the main body 410 and has a movable drilling unit 440 having a plurality of cutting edges 441 and a cutting unit 442 as shown in FIG. 4b, which are configured to form a three-dimensional feature for the computer numerical control (CNC) machine. In one embodiment, the movable drilling unit 440 has a center hole 443 and a rivet 444 is inserted into the center hole 443 to movably secure the drilling unit 440 to the functional head 430.

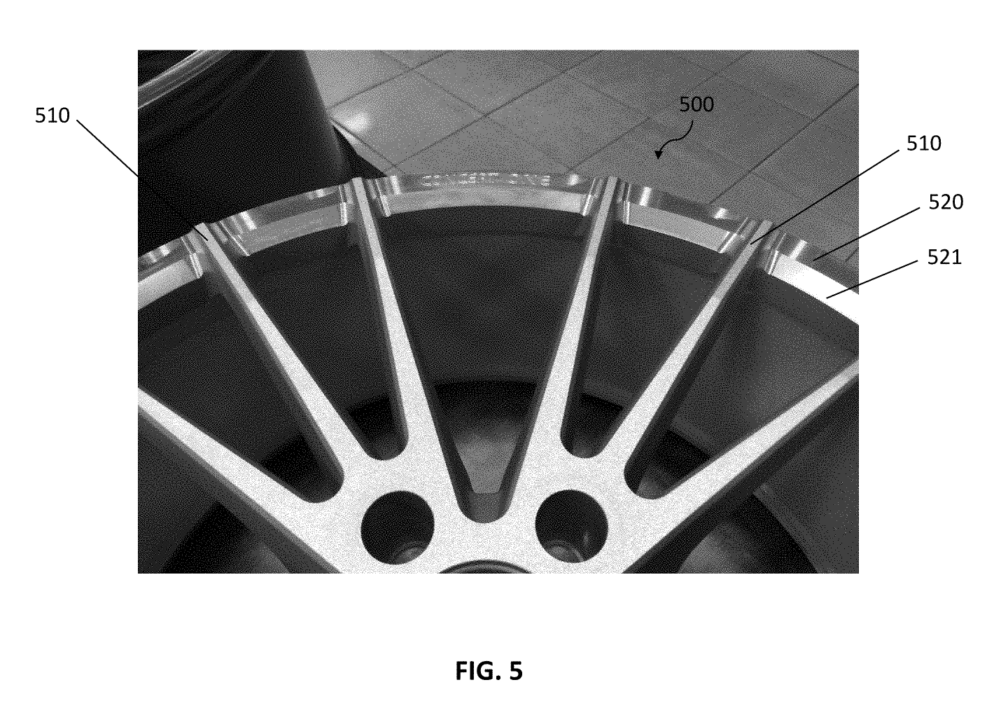

More specifically, as shown in FIG. 5, a vehicle wheel 500 has a plurality of spikes 510 radially extending from a center of the vehicle wheel 500. With the movable drilling unit 440 and the cutting unit 442, the CNC machine can generate a three-dimensional feature like the spikes 510. Comparing with a periphery portion 520 of the vehicle wheel 500, the spikes 510 are protruding from the surface of the periphery portion 520 to form a three-dimensional feature. It is noted that a slanted periphery 521 that is slantedly extending from the periphery portion 520 toward the center of the vehicle wheel 500 can also be formed by the movable drilling unit 440 and the cutting unit 442.

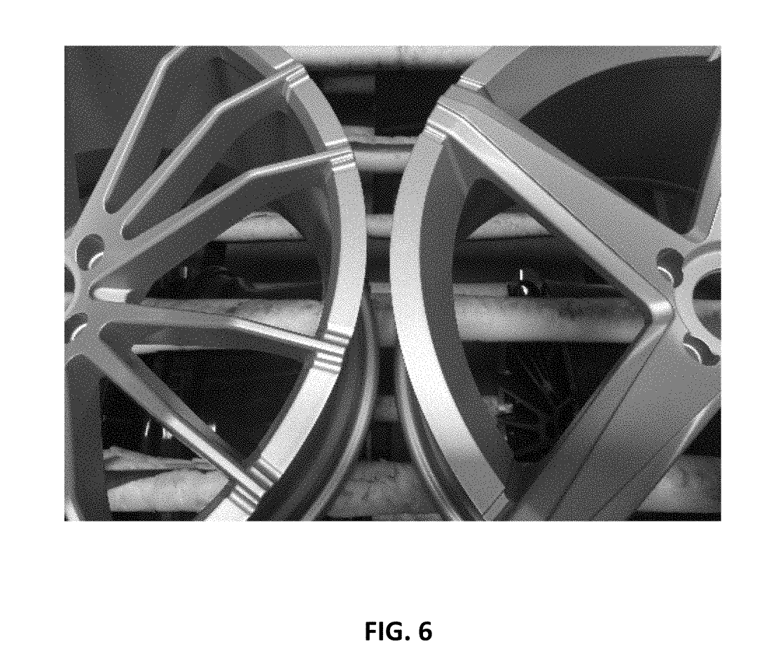

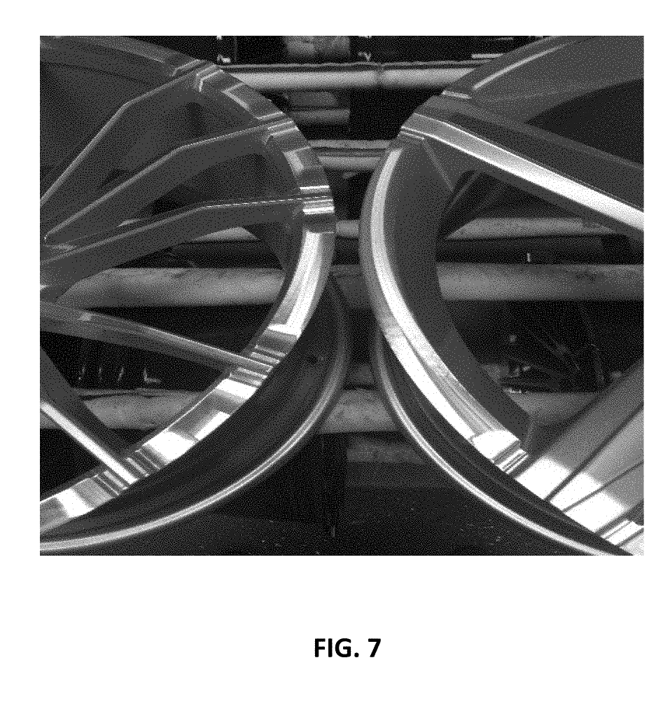

In an exemplary embodiment, the movable drilling unit 440 is an artificial diamond, which can be used to polish the wheel to increase the brightness thereof with predetermined parameters set in the CNC machine. FIG. 6 shows the wheels before being polished by the CNC machine with the artificial diamond, and FIG. 7 shows the same wheels after being polished by the CNC machine, the brightness of which is significantly increased.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A method for forging a vehicle wheel with three-dimensional features comprising steps of utilizing toe-clamps and center collets to reduce chatter marks and the effects of vibrations and harmonics; employing a parametric computer numerical control (CNC) program which allows for feed rates and spindle RPM speeds that are specific to the process of the vehicle wheel design; utilizing end-mills, bull-nose end-mills, ball-mills, chamfer tools, V-tools, custom rivet tools, and other commonly used CNC milling tools to machine the sides of the spokes on the wheels; utilizing a coolant to operate the CNC machine; providing a tool to form said three-dimensional features on the wheel; cleaning the wheel to remove coolant and debris remaining on the wheel; and painting selected areas of the wheel.

2. The method for forging a vehicle wheel with three-dimensional features of claim 1, wherein the tool to form said three-dimensional features on the wheel includes a main body, a functional head extending from one end of the main body, a movable drilling unit having a plurality of cutting edges, and a cutting unit.

3. The method for forging a vehicle wheel with three-dimensional features of claim 2, wherein the movable drilling unit has a center hole, and a rivet is inserted into the center hole to movably secure the drilling unit to the functional head.

4. The method for forging a vehicle wheel with three-dimensional features of claim 2, wherein the movable drilling unit is an artificial diamond configured to polish the wheel to increase the brightness thereof.

5. The method for forging a vehicle wheel with three-dimensional features of claim 2, wherein the tool to form said three-dimensional features on the wheel further includes a spiral head.
